(19) United States
(12) Patent Application Publication
(10) Pub. No.: US 2005/0153185 A1
(43) Pub. Date: Jul. 14, 2005

(54) Solid polymer type fuel cell electricity generation block and fuel cell stack

(76) Inventors: Tadashi Yoshida, Hitachi (JP); Masahiro Komachiya, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/028,214

(22) Filed: Jan. 4, 2005

(30) Foreign Application Priority Data
Jan. 9, 2004 (JP) 2004-003947

(51) Int. Cl. H01M 8/04; H01M 2/08; H01M 8/10; H01M 8/02

(52) U.S. Cl. 429/26; 429/32; 429/35; 429/38

(57) ABSTRACT

A polymer type fuel cell electricity generation block wherein a plurality of fuel cell units each comprising an electrode-electrolyte assembly is stacked with a pair of cooling separators each having a gas passage in one face and a cooling passage in the other face in such a manner that the gas passage is located inside.

### CLAIM OF PRIORITY

The present application claims priority from Japanese patent application serial No. 2004-003947, filed on Jan. 9, 2004, the content of which is hereby incorporated by reference into this application.

### DESCRIPTION OF THE INVENTION

1. Field of the Invention

The present invention relates to an electric power generation block of a solid polymer type fuel cell and a fuel cell stack using the same.

2. Related Art

There is disclosed a stack structure of a solid polymer type fuel cell in the patent document No. 1. In this structure, without using an O-ring or a bracket type gasket, which has been used as a gas sealing member, a polymer sheet with an adhesive having a window in the center part thereof is bonded to one face or both faces of an electrolyte membrane so that the whole stacked members are integrated by the bonding structure. Since the size of the window in the center of the sheet is smaller than the outer peripheries of electrodes and gas diffusion plates, the electrolyte membrane, the electrode and the diffusion plate are bonded and united by the polymer sheet with the adhesive. Accordingly, in order to constitute the stack, the sheets (diffusion plate—electrode—membrane—electrode—diffusion plate) and separators are stacked alternately to manufacture a united stack.

However, this conventional structure has following problems. At first, since the adhesive bonds the whole constituting members for the stack, it is impossible to replace or exchange part of cells or elements of the cells if some troubles happen in the cells after assembly of the stack.

Further, since the electrolyte membrane, electrodes and diffusion plates are united, the outer peripheries of the electrodes and the diffusion plates overlap the inner portion of the window if the size of the window of the polymer sheet with the adhesive is made smaller than the outer peripheries of the electrodes and the diffusion plates. It is necessary to press the overlapped portion down to the thickness smaller than the total thickness of the electrodes and the diffusion plates and the polymer sheet. This may cause a large stress and strain of the separators opposing to the overlapped portion so that performance of the cell stack may be adversely affected. As adverse affects, there are decrease in gas sealing-ness, decrease in electric conductivity due to uneven pressure among the stacked members i.e. an increase in inner resistance.

As for a countermeasure to the trouble in part of the cells during the operation of the fuel cell, it is considered that the stack is separated into several sections or blocks in advance. Each of the sections is integrated and united. If a trouble happens in one or several blocks, the defect block or blocks are replaced or exchanged with a sound block or blocks.

A typical example of this countermeasure is disclosed in the patent document No. 2. However, the method disclosed in the publication No. 2 needs a fastening structure for each of the blocks and another fastening structure for the stack that is constituted by the blocks. This leads to a complicated and large sized structure.
Patent document No. 1: Japanese patent laid-open 09-289028
Patent document No. 2: Japanese patent laid-open 10-261426

### SUMMARY OF THE INVENTION

The present invention aims at providing a polymer electrolyte type fuel cell stack wherein a plurality of electric power generation blocks is stacked and united, wherein the electric power generation blocks are of easy maintenance.

According to the present invention, there is provided a fuel cell electric power generation block sandwiched between a pair of cooling separators each having a gas flow passage on one face thereof and a cooling medium flow passage on the other face thereof, wherein the block is constituted by a fuel cell unit and an electrode-membrane assembly (hereinafter referred to as MEA) wherein each of the faces of a pair of separators having a flow passage for a cooling medium is come to an inner side or a position near the MEA. That, is, the flow passage is in contact with a gas diffusion plate, which is in contact with the electrode of the MEA.

In the specification, the MEA stands for a Membrane—Electrode Assembly. In the block, it is preferable that each of the fuel cells are united and the cooling separators and the fuel cell units are united. A fluid seal member can be bonded to one side or both sides of the cooling separators of the block. This fluid seal member seals the cooling medium between the cooling separators of the adjoining blocks.

The fluid seal member is preferably made of a compressive material or a material to be compressed. This fluid seal member can be bonded to the cooling separators. The fluid seal member includes a liquid seal member for water, for example, and a gas seal member. In the present invention, when water is used as the cooling medium, a liquid seal can perform the sealing function, but the gas seal member which has been used can be used, too.

The present invention provides a fuel cell stack constituted by sandwiching a unit comprising a gasket, a gas diffusion plate, MEA, a gas diffusion plate and a gasket between a pair of separators each having a gas flow passage on one face thereof and a cooling flow passage on another face thereof.

According to the present invention, it is possible to perform easily an assembly of the fuel cell stack, replacement or exchange of parts or blocks thereby to conduct easy maintenance of the fuel cell stack.

### BRIEF DESCRIPTION OF THE DRAWINGS

FIG. 1 is a partial sectional development of a fuel cell stack of the embodiment of the present invention.

FIG. 2 is a cross sectional view of an electric power generation cell used in the fuel cell stack of the present invention.

FIG. 3 is a cross sectional view of another embodiment of the present invention.

### DETAILED DESCRIPTION OF THE PREFERRED EMBODIMENTS

In the following, the embodiments of the present invention will be explained in detail by reference to drawings.

In an embodiment of the present invention, the stack structure is constituted by a plurality of blocks wherein constituting members are united by bonding or adhesion, and wherein the cooling cell is formed at the boundary between the blocks. The size of the window formed in the center of the fluid seal or an adhesive seal between the blocks is preferably made larger than the outer peripheries of the electrodes and diffusion plates.

When the liquid seal is bonded to the separator, handling of the stack becomes easy. When a desired number of the blocks are stacked, the fuel cell stack is obtained. Therefore, it is possible to inspect or repair the fuel cell stack block by block.

When the stack is constructed, connection between the blocks is performed by a technique similar to that of the connecting conduits for cooling medium. Unless the blocks have no problems in power generation capability, the stacks can be constructed easily. Accordingly, the fuel cell stack of the present invention can be constructed at a site where the fuel cell stack is operated, because the blocks that have been inspected and subjected to electricity generation performance test in a fuel cell production factory are simply bonded without a further inspection or examination at the site. If a trouble happens during power generation or blocks should be replaced, replace or repair is carried out block by block. Thus, the maintenance of the fuel cell stack is extremely simplified.

Further, since the stack is united by fastening the plural blocks into the united stack, transportation, installment and movement of the fuel cell is very easy. In addition to that, the present invention provides a solid polymer type fuel cell stack wherein a plurality of blocks each comprising a separator having a cooling flow passage for cooling water, etc. on one face thereof and a gas flow passage on the other face thereof, a unit comprising a gasket disposed on the gas flow passage side, a gas diffusion plate, MEA, a gas diffusion plate and a gasket and a compressive liquid seal or fluid seal member bonded to the cooling medium flow passage side of the separator.

When the fluid seal layer is used as a bifacial bonding sheet or two faces bonding sheet, the cooling separators between the blocks can be easily bonded and fixed so that the handling of the stack becomes easier. Further, when one or more grooves or holes for inserting tools for separating the blocks are formed in the separator located at the boundary between the blocks, disassembly of the blocks can be carried out easily so that replacement, exchange, inspection, repair, etc. of elements or blocks can be done easily.

The fluid seal member has a window in the center part of thereof, the area of which is larger than the outer periphery diameters or the size of the MEA and the diffusion plates; the fluid is surely sealed. The fluid seal member may not have a window. In this case, at least the center portion of the fluid seal member should preferably be sufficiently porous so that the cooling medium flowing in the flow passage of the separator is not hindered. The fluid seal member should preferably be made of fibrous composite material or a flexible porous material so that the seal member becomes compressive or made compressed. As a result, the leak of fluid is prevented and a compression force is uniformly distributed over the blocks when the stacked blocks are fixed.

In a more preferable structure of a fuel cell stack, all members constituting each of the blocks are bonded and united by an adhesive, and a cooling cell is sandwiched between the united blocks. As a result, maintenance of the stack becomes easy. When an inner size of the window of the gasket is made smaller than the outer peripheries of the electrode and the diffusion plate, overlapping of the elements is eliminated so that gas sealing property and electric conductivity are good. In the united block structure wherein a bonding sheet is used as a fluid seal member, the united block structure with good fluid sealing property and electric conductivity are provided.

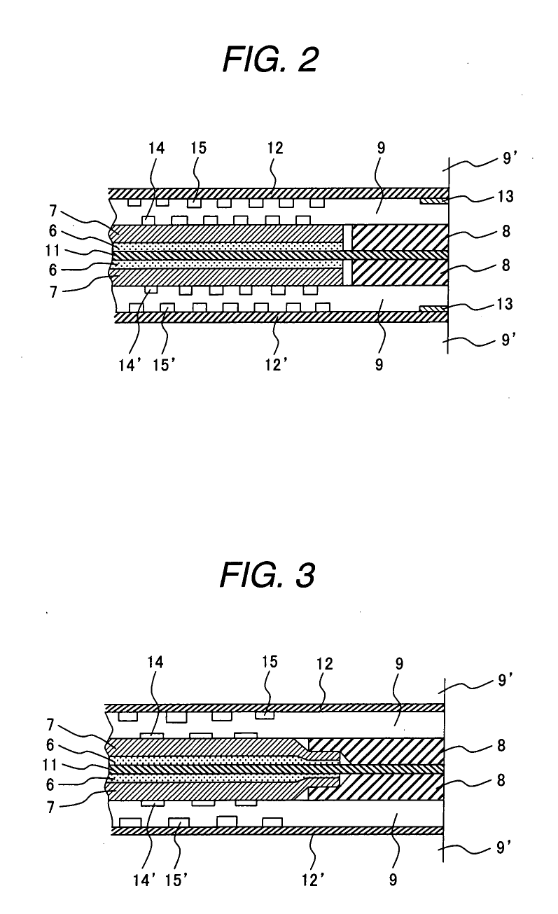

The structure uniting the members that constitute the fuel cell stack is inspected or the members are easily replaced, even when a trouble happens in a part of the cell stack. When the members for stack or the blocks are united by bonding or adhesion, the outer peripheries and the inner part of members are overlapped. Accordingly, the number of the assembling members can be reduced. In order to relieve the stress in the overlapped portion, MEA, the gas diffusion plates, the electrodes and gaskets are not overlapped as shown in FIG. 2, whereby adverse affects on gas sealing property and electric conductivity are avoided.

The blocks are united by bonding or adhesion of the constituting members. In the fuel cell stack constituted by stacking the blocks, many minute members for cooling cells are not necessary because the cooling cells are disposed at the boundary of the blocks. As a result, replacement work for replacing blocks at the time of maintenance of the fuel cell becomes easy.

At the same time, it is unnecessary to carry out confirmation of the fuel cell performance of the blocks at the site of the fuel cell operation. It is possible to adapt adhesion structure between cooling cells for simplification of the stack structure. Further, in the adhesion structure of the constituting members of the blocks, the outer periphery size of the gasket having the window is made larger than the outer periphery sizes of the electrodes and the diffusion so that the decrease in the gas sealing property and electric conductivity that are induced by the stress in the overlapped portion are prevented.

The present invention employs the united structure of the bonding structure or adhesion structure of the constituting members; thus, upper and lower fastening plates and fastening bolts for uniting the blocks are not necessary or small sized fastening members are acceptable. Therefore, the fuel cell stack is downsized and light-weighted, and the structure is very simplified.

In the stack where plural blocks are piled or stacked, since the boundaries of the blocks are cooling cells, it is not necessary to disassembly the cells of the stack at the time of maintenance of the stack. Accordingly, disassembly—assembly of the elements and bringing back the elements to the factory are not necessary. As a result, maintenance fee and steps are reduced; the stability of the performance of the fuel cell after the maintenance and the easiness of the maintenance are secured.

According to the embodiment of the present invention, a plurality of blocks each being united by bonding wherein a cooling cell is disposed between the blocks. It is preferable that the size of a window formed in the center of the fluid seal or a bonding seal between the blocks is larger than the size of the outer periphery of the electrode and the diffusion plates.

The preferred embodiments of the present invention will be explained by reference to the drawings.

### EMBODIMENT 1

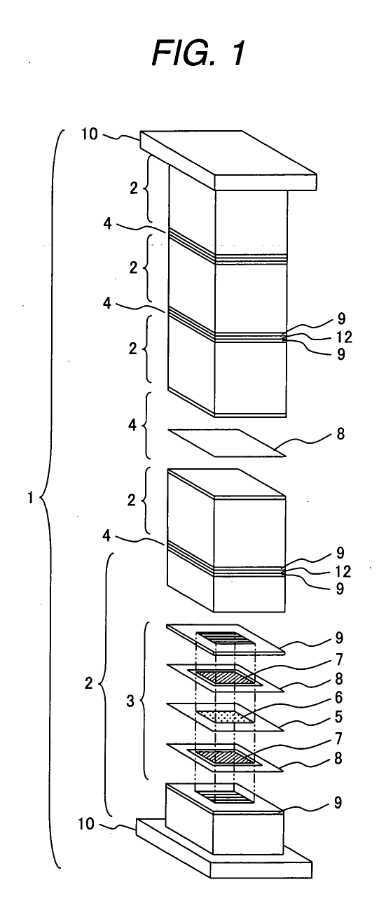

FIG. 1 shows a perspective development of a fuel cell stack of the present invention. The stack comprises a plurality of blocks 2, a pair of cooling separators 9 sandwiched between the blocks and fluid seal members 12 sandwiched between the separators 9. The fluid seal is made of a compressive porous material. Thus, the boundaries of the blocks are cooling cells.

An electricity generation cell and the cooling cell constitute each of the blocks. The electricity generation cell comprises MEA 5, a diffusion plate 7 imposed on an electrode of the MEA, and a gasket 8 having a window with a size larger than outer peripheries of the electrode 6 and diffusion plates, the gasket being imposed on the diffusion plate. 20 to 30 of the fuel cell units constructed above are stacked to constitute an electricity generation unit. The electricity generation cell unit is sandwiched by the cooling separators.

The both faces of the gasket have an adhesive layer for bonding the MEA and the separators. In this embodiment, the diffusion plates are separated from the other parts; the diffusion plates may be bonded to the electrode of MEA. This can be done by a newly developed technology for assembling or uniting elements. It is preferable to use the united MEA and diffusion plates so as to reduce the steps of assembly. When stacking MEA (with the diffusion plates)→the gasket (with the adhesive)→the separator→the gasket (with the adhesive)→MEA (with the diffusion plate), all members constituting the electricity generation blocks are totally bonded or adhered to constitute a united structure.

The cooling cells for forming the boundaries of the blocks are constituted by the gaskets and contact with the separators located at the ends of the blocks. When the both faces of, the gasket are adhesive, the blocks are bonded to make a united body.

When none of the both faces of the gasket are adhesive, the stack structure is fixed to seal the cooling water by fastening bolts, etc disposed between end plates located on the upper and lower ends or right and left ends of the stack. The fastening of the end plates is effective in case where the cooling cells between the blocks are adhesion structure, because this structure does not impart separation force to the bonding faces.

Employment of adhesion structure of the cooling cells or of fastening structure of the end plates is determined in considering the scale of the stack, installment circumstances, etc. For example, if an output of the stack for use in portable fuel cells which require space saving is as small as only several watts, the united structure free from the fastening structure is preferable so as to simplify the structure and to provide a light weight fuel cell stack.

On the other hand, fuel cells for automobiles, since the output is as large as several tens k watts and anti-vibration is needed, the united structure and fastening structure are preferably employed.

Further, in case of small scale stationary type fuel cells with an output of several k watts, the cooling cells between the blocks are not adhesion structure for reducing a cost and easiness of maintenance. The whole stack is fastened to secure sealing of the blocks. In case where the cooling cells are adhesion structure, it is preferable to form grooves or holes into which disassembly tools are inserted in the separator 13 located at the end of the stack for maintenance of the fuel cell stack.

FIG. 2 shows a cross sectional view of an electricity generation cell unit in a block of the present invention. The adhesion face may be one face or both faces of the gasket. The adhesion face may be on the one or both faces of the MEA. One or both faces of the separators are acceptable for bonding. Any combinations of the above structures are acceptable to the invention.

### EMBODIMENT 2

The inner size of the window of the gasket is made larger than the outer peripheries of the electrodes and the diffusion plate so that the inner peripheries of the electrodes and diffusion plates of MEA and the inner periphery of the gasket do not overlap each other. If the outer peripheries of the electrodes and the diffusion plate overlap with the inner periphery of the window of the gasket, deformation of the overlapped portion as shown in FIG. 3 may take place, when a fastening force is applied to the overlapped portion thereby to bond the elements. This deformation may induce deformation among the elements to give adverse affects on fluid sealing and electric conductivity. However, the present invention may be applied to this type of fuel cell stack.

According to the present invention, the assembly and disassembly, replacement, transportation and movement of the stack are done easily and effectively, because the gasket is one face bonding type or bifacial bonding type or the fluid seal is one face bonding type or bifacial bonding type.

The fluid seal layer and the gasket can be made of the same material or different materials. The gasket functions to seal hydrogen containing gas and oxygen containing gas and the fluid seal layer functions to seal a cooling medium such as cooling water that flows through the cooling separator. Accordingly, the fluid seal may be sufficient if it can seal cooling medium sufficiently. The materials for the gasket and the fluid sealing member should preferably be compressive. As a result, a pressure applied to the separator and MEA, etc is uniformly distributed so as to prevent them from being broken, damaged or deteriorated. According to the present invention, each of the fuel cell blocks can be made rigidly; i.e., stacked layers of the blocks can be fastened altogether, while the fuel cell stack can be separated into several blocks. Therefore, the maintenance of the fuel cell stack becomes quite easy. Each end of the block is preferably provided with a cooling layer, which is suitable for splitting or dividing the fuel cell stack into several blocks, because the cooling layers can be designed independently from the unit cell structures, which are quite delicate ones.

The fuel cell stack mentioned-above may further include another cooling layers.

1. A polymer type fuel cell electricity generation block wherein a plurality of fuel cell units each comprising an electrode-electrolyte assembly is stacked with a pair of cooling separators each having a gas passage in one face and a cooling passage in the other face in such a manner that the gas passage is located inside of the unit.

2. The polymer type fuel cell electricity generation block according to claim 1, wherein each of the fuel cell units comprises a gasket, a gas dispersion plate, an electrode-electrolyte assembly, a gas dispersion plate and gasket.

3. The polymer type fuel cell electricity generation block according to claim 1, wherein the cooling separator and the unit cell are bonded and/or united.

4. The polymer type fuel cell according to claim 1, wherein a liquid seal member is connected to the cooling separator.

5. A polymer type fuel cell stack comprising a plurality of fuel cell electricity generation blocks which are stacked, wherein each of the blocks is constituted by fuel cell unit cells having an electrode-electrolyte assembly sandwiched by a pair of separators each having a gas flow passage on one face thereof and a passage for cooling medium on the other face thereof, the gas flow passage being in the inner side of the unit.

6. The polymer type fuel cell stack according to claim 5, wherein each of the electricity generation blocks is constituted by sandwiching a gasket, a gas diffusion plate, the electrode-electrolyte assembly, a gas diffusion plate and a gasket between the pair of the separators.

7. The polymer type fuel cell stack according to claim 5, wherein a liquid seal is disposed between the cooling separators of the adjoining electricity generation blocks.

8. The polymer type fuel cell stack according to claim 5, wherein the plural electricity generation blocks are stacked and united by a fastening structure.

9. The polymer type fuel cell stack according to claim 7, wherein the liquid seal is a bifacial adhesive sheet.

10. The polymer type fuel cell stack according to claim 5, wherein a groove or a hole into which a disassembling tool is inserted is formed in the separator at the boundary of the blocks.

11. The polymer type fuel cell stack according to claim 7, wherein the fluid seal layer has a window, an area of the window being larger than the outer peripheries of the electrode-electrolyte assembly and the gas diffusion plate.

12. The polymer type fuel cell stack according to claim 7, wherein the fluid seal layer has no window and is porous.

13. A polymer type fuel cell stack comprising a plurality of electricity generation blocks each comprising a pair of separator each having a gas flow passage on one face thereof and a cooling medium flow passage on another face thereof, a gasket, a gas diffusion plate, an electrode-electrolyte assembly, a gas diffusion plate, and a gasket, the blocks being stacked through a compressive fluid seal at the cooling medium flow passage.
